(19) United States
(12) Patent Application Publication
(10) Pub. No.: US 2009/0135175 A1
(43) Pub. Date: May 28, 2009

(54) VISUALIZATION OF A RENDERED MULTI-DIMENSIONAL DATASET

(75) Inventors: Steven Lobregt, Eindhoven (NL); Hubrecht Lambertus Tjalling De Bliek, Eindhoven (NL); Cornelis Pieter Visser, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,012

(22) PCT Filed: Oct. 27, 2005
(86) PCT No.: PCT/IB05/53517

§ 371 Date: Apr. 26, 2007

(30) Foreign Application Priority Data
Mar. 29, 2007 (EP) 04105439.6

(51) Int. Cl. G06T 15/00

(52) U.S. Cl. 345/419

(57) ABSTRACT

A method of visualization of a multi-dimensional dataset of data-elements involves rendering process in which a display-value and an opacity value are assigned to individual data-elements. The display-values are determined on the basis of a histogram of the data-values of the multi-dimensional dataset. The histogram being is displayed in combination with a separate distribution of display-values.

The invention pertains to visualization of a rendered multi-dimensional dataset.

In general multi-dimensional datasets are built-up from individual data-elements (often termed pixels or voxels) that assign data-values to positions in a multi-dimensional geometrical space, notably a volume. Typically data-values concern values of physical quantities, such as density, local magnetization, flow velocity, temperature etc.. Usually the multi-dimensional geometrical space is a three-dimensional volume or a two-dimensional surface or plane. One of the dimensions of the multi-dimensional geometrical space may be time, that is multi-dimensional datasets include datasets over 3D+time or 2D+time.

To visualize such a multi-dimensional dataset on an essentially two-dimensional display screen generally a rendering process is applied. Such a rendering process involves the assignment to the data-element of a display-value, typically a color value or a grey value, as well as an opacity value. The opacity value of a data-element represents the way that individual data-element influences the visualization of other data-elements on the basis of their relative positions. The display-value of a data-element represents the way the data-element is visualized in itself.

A method of visualization a multi-dimensional dataset is known from the German patent application DE 100 52 540.

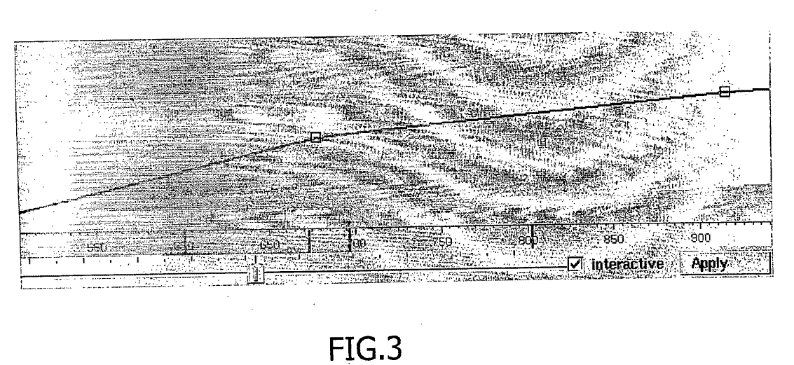

The known visualization concerns a three-dimensional dataset of grey values to which volume rendering is applied. The volume rendering involves a transfer function that assigns to each grey value an RGBA-value that has a transparency value (A) and a mixture of red(R), green(G) and blue(B). The known transfer function assigns transparency values to the grey values of the three-dimensional dataset according to a graph that has the shape of several trapezia, (as shown in FIG. 3 of the cited German patent application). The transfer function is adjusted on the basis of a histogram of the grey values of the three-dimensional dataset. The transfer function is adjusted by setting the corners and height of the trapezia, in this way the transparency value is controlled. For each part of the transfer function relating to a particular trapezium color and brightness are assigned to the grey values.

An object of the invention is to provide a method of visualization in which adjustment of the rendering process is more user friendly.

This object is achieved by the method to visualize the multi-dimensional dataset wherein individual data-elements assign a data-value to a position in a multi-dimensional geometrical space and

the visualization includes
a rendering process in which a display-value and/or an opacity value are assigned to individual data-elements of the multi-dimensional dataset and the display-values being determined on the basis of a histogram of die data-values of the multi-dimensional dataset
the histogram being displayed in combination with a separate distribution of display-values.

The invention is based on the insight that in order to adjust the rendering process on the basis of the histogram user friendliness is improved by showing both the histogram and the range of display-values that can be assigned under good or excellent viewing circumstances. Because both are shown in combination, the user is provided with an intuitive way to adjust the rendering process as concerns the way display-values are assigned to (ranges) of display-values. The display value enables to visually distinguish structures within the volume, provide insight in relationships between structures within then volume, or to indicate or emphasize the presence of specific data-values. Often the data-value is a scalar quantity such as density, temperature etc.

Most satisfactory results are achieved by displaying the histogram over a background formed by a distribution of display-values. In this way a direct relationship between the histogram and the display-values is provided. This makes selection of display-values to be assigned to data-value ranges on the basis of the histogram easy. In particular, a good rendition of available display-values in portions of the histogram where the incidence of data-values in the histogram is low.

The invention further relates to a workstation which has the function to visualise a multi-dimensional dataset. To this end the workstation has an input to receive multi-dimensional dataset, a processor to performer the visualisation process and a display screen on which the result of the visualisation process is shown..The workstation of the invention is defined in Claim 3. The workstation of the invention is enabled to perform the visualisation of the invention and accordingly allows the user to adjust rendering process, and notably the assignment of display-values to (ranges of) data-values in the visualisation in a more intuitive and better controlled way. The invention also relates to a computer program that can be installed b the processor of a e.g. general purpose workstation. The computer program of the invention is defined in Claim 4. When the computer program of the invention is installed in the processor of the workstation, then the workstation is enabled to perform the visualisation of the invention and accordingly allows the user to adjust the visualisation in a more intuitive and better controlled way.

These and other aspects of the invention will be further elaborated with reference to the embodiments defined in the dependent Claims.

These and other aspects of the invention will be elucidated with reference to the embodiments described hereinafter and with reference to the accompanying drawing wherein

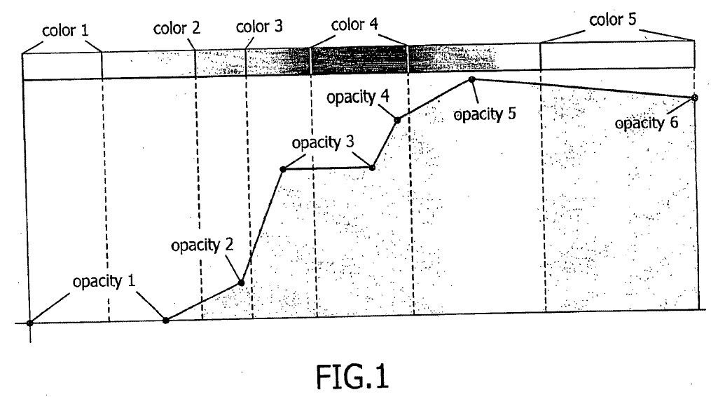

FIG. 1 shows a proposed approach for flexible and simple definition of color and opacity map that represents the transfer function

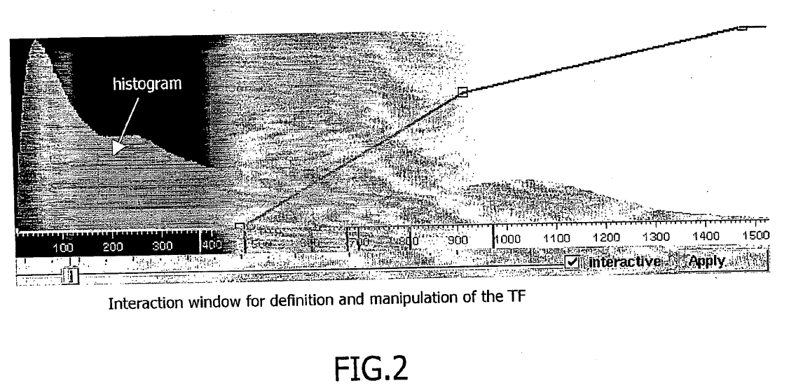

FIG. 2 shows an interaction window for definition and manipulation of the transfer function

FIG. 3 shows zoom-in for accurate definition of colors and opacity and

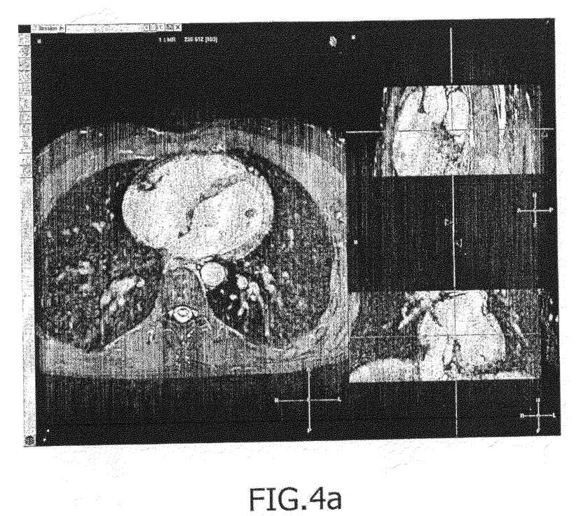

FIG. 4 shows a) an example of original voxel data (cross-section), and b) the resulting rendered image

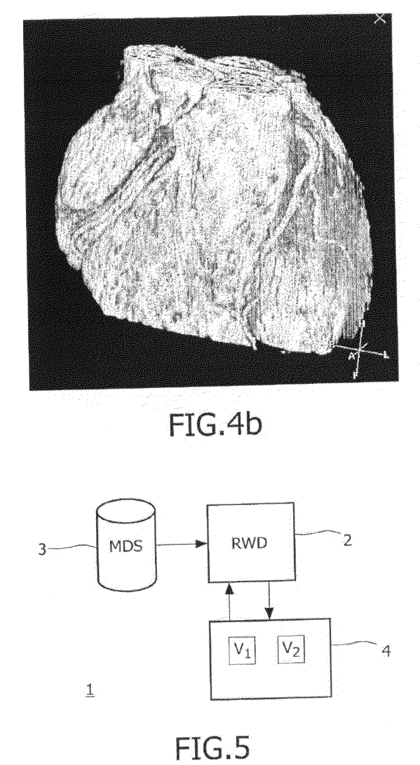

FIG. 5 shows a diagrammatic representation of a workstation in which the present invention is employed.

The method of visualization of the invention defines colors at the exact voxel values where the user want them to be. Colors are interpolated between defined positions that represent the control sets. A voxel value range (segment) with constant color throughout this range can be realized by setting equal colors at the borders of the intended range.

Opacities are defined in exactly the same way as colors. Colors and opacities are completely independent of each other. FIG. 1 shows an example of graph of the transfer function (TF) in the form a color and opacity map including three segments with constant color and two segments with constant opacity

A color which is set at a certain voxel value or for a certain range of voxel values will not change when an adjacent color value or its related voxel value is modified. The same goes for assigned opacity values. It is therefore assured that once a color or opacity is assigned to a voxel value, it will not change unless it is itself deliberately modified by the user.

The number of voxel values for which a color or an opacity is defined is free to choose for the user. Definition points the correspond to the control sets, for color or opacity can be simply added or deleted.

The fact that color and opacity are independent of each other gives the advantage that they both can be modified without affecting the other. For instance: a tissue type (voxel value range) can thus be given a certain color, while the translucency (opacity) in the rendered image can still be varied without changing its color. The approach of the invention is simple and offers maximum flexibility.

The transfer function (TF) is defined in a UI window, which displays the voxel value histogram as an overlay on a colored background, which represents the defined colors. In our implementation, the histogram is shown as a grey translucent overlay, while the color values are shown over the complete height of the image in the background, so that the defined colors are clearly visible, independent of the height or the presence of the histogram.

The TF can be defined from scratch or it can be loaded from a storage as a default TF or a previously created one.

The positions where the colors are defined along the horizontal voxel value axis are indicated by vertical indicator lines in the strip along the lower part of the image. The defined opacity map is shown as a graphic overlay in the form of a polyline, where the nodes of this polyline represent the defined voxel value/opacity combinations. The horizontal position represents the voxel value, while the vertical position of the nodes represents the opacity for that voxel value. See FIG. 2

Modifying the voxel value for which a color is defined is done by simply dragging the corresponding vertical line to another horizontal position. Modifying the color, which is assigned to a voxel value, is done by selecting the corresponding line, after which a color selection panel is popped up. Modifying a defined combination of voxel value and opacity is done by selecting the corresponding node of the opacity representing polyline and dragging it to another horizontal and/or vertical position. Using simple mouse button and keyboard combinations, new combinations of voxel value and color or opacity can be added or existing combinations deleted.

Additional functionality which is currently included in a prototype implementation of the proposed method to increase user friendliness and ease of use, include translation and stretching (zoom in horizontal direction) of the color or opacity map relative to the histogram, and translation/stretching of the combination of histogram and complete TF for better visibility of details. See fig. 3.

The visualization of coronary arteries directly from MR, is an example where the proposed method can be applied. However, it should be noted that the method is applicable to any situation where direct volume rendering (DVR) is used for visualization.

FIG. 4a shows one cross-section out of an acquired 3D MR dataset which covers the complete heart area and surrounding structures. An adequate TF is shown in FIG. 2, and the rendering that results from this TF is shown in FIG. 4b. Preferably, links are established between corresponding positions in the rendered image and the relevant cross-section of the 3D MR dataset. When the user indicates a position in the rendered image, on the basis of the link the corresponding position in the relevant cross section is shown (or vice versa). Thus, the user may identify an area that is suspected of a lesion, such as a stenosis, in the rendered image and may look for confirmation of the presence of a lesion in the relevant cross section (or vice versa).

FIG. 5 shows a diagrammatic representation of a workstation in which the present invention is employed. The workstation 1 comprises a rendering system 2 which has access to the multi-dimensional dataset 3. The workstation 1 is provided with a user interface with a display screen that has several view ports V1, V2. On one view port the transfer function with the control sets in the form of definition points is shown. The user may adapt the transfer function by manipulating the definition points. Also the color settings at the boundaries of ranges of data-values may be user defined aided by the view port V1. The corresponding settings for the rendering process are applied to the rendering system 2. The rendering system performs a rendering process, such as direct volume rendering and supplies the rendered multi-dimensional dataset to the user interface to be displayed e.g. in one of the view ports. Notably different view ports are employed to display the transfer function and to display the rendered multi-dimensional dataset.

1. A method of visualization of a multi-dimensional dataset of data-elements
individual data-elements assigning a data-value to a position in a multi-dimensional geometrical space and
the visualization including
a rendering process in which a display-value and/or an opacity value are assigned to individual data-elements of the multi-dimensional dataset and the display-values being determined on the basis of a histogram of the data-values of the multi-dimensional dataset
the histogram being displayed in combination with a separate distribution of display-values and/or opacity values.

2. A method of visualization a multi-dimensional dataset as claimed in claim 1, wherein the histogram is displayed over a background of the distribution of display-values.

3. A workstation to visualize a multi-dimensional dataset comprising
a rendering system arranged to
perform a rendering process in which a display-value and an opacity value are assigned to individual data-elements of the multi-dimensional dataset according to a transfer function that induces a relationship between data-values and opacity and/or display values and
to assign a display-value and/or an opacity value to individual data-elements of the multi-dimensional dataset and the display-values is determined on the basis of a histogram of the data-values of the multi-dimensional dataset and
the workstation comprising a user interface arranged to
display the histogram in combination with a separate distribution of display-values and/or opacity values.

4. A computer program including instructions
to perform a rendering process in which a display-value and an opacity value are assigned to individual data-elements of the multi-dimensional dataset and according to a transfer function that induces a relationship between data-values and opacity and/or display values,
to assign to individual data-elements of the multi-dimensional dataset and the display-values being determined on the basis of a histogram of the data-values of the multi-dimensional dataset and to
display the histogram being in combination with a separate distribution of display-values and/or opacity values.
